(19) United States
(12) Patent Application Publication
(10) Pub. No.: US 2008/0032033 A1
(43) Pub. Date: Feb. 7, 2008

(54) Grain Protein Formulations That Provide Clean Release From Molding Surfaces, And Associated Methods

(75) Inventors: Li Nie, Parkville, MO (US); Sukh D. Bassi, Atchison, KS (US); Michael D. Parker, Shawnee, KS (US)

Correspondence Address: LATHROP & GAGE LC, 4845 PEARL EAST CIRCLE, SUITE 300, BOULDER, CO, 80301, US

(73) Assignee: MGP INGREDIENTS, INC., Atchison, KS (US)

(21) Appl. No.: 11/780,425

(22) Filed: Jul. 19, 2007

Related U.S. Application Data
(63) Continuation-in-part of application No. 10/617,565, filed on Jul. 11, 2003.
(60) Provisional application No. 60/831,985, filed on Jul. 19, 2006.

(51) Int. Cl. A23J 1/00

(52) U.S. Cl. 426/656

(57) ABSTRACT

Grain protein formulations that cleanly release from molding surfaces, reduce mold cycling time and improve product appearance, texture and digestibility are disclosed. Properties of the grain protein formulations are enhanced by the addition of compounds such as calcium salts, magnesium salts, Ba(OH)₂, BaO, Na₂CO₃, NaOH, KOH, food grade phosphates and mixtures thereof. Articles of manufacture formed from the formulations may, for example, be pet chew treats, edible products and biodegradable articles.

### RELATED APPLICATIONS

This application is a continuation-in-part of commonly-owned and copending U.S. patent application Ser. No. 10/617,565, filed Jul. 11, 2003, and claims the benefit of priority to U.S. Provisional Patent Application No. 60/831,985, filed Jul. 19, 2006, each of which is incorporated herein by reference.

### FIELD OF THE INVENTION

The present invention relates to grain protein formulations that cleanly release from molding surfaces, significantly reduce molding cycle time and improve product texture, appearance and digestibility. The formulations are enhanced by the addition of compounds such as calcium salts, magnesium salts, Na₂CO₃, NaOH, KOH, food grade phosphates and mixtures thereof. Articles of manufacture formed from the formulations may, for example, be pet chew treats, edible products and biodegradable articles.

### BACKGROUND

U.S. Pat. No. 5,665,152 issued to Bassi et al., which is incorporated herein by reference, describes formulations and processing methods for forming grain protein products. In general, grain protein formulations, such as those of the '152 patent, are prepared as resin pellets that are later melted and formed into shaped articles of manufacture. However, when the pellets are not formed into shaped articles shortly after resin production, e.g., a few weeks, the molded articles begin to show signs of rough and bumpy surfaces due to aging of the resin pellets and the strength of molded articles begins to decrease.

In U.S. patent application Ser. No. 10/617,565, resin pellets having improved aging characteristics are disclosed. The pellet formulations contain a high level of hydrolyzed protein, which improves shelf life but adversely affects product texture and structural integrity, as well as complicates molding because the products tend to stick to molding surfaces instead of cleanly releasing. Adjusting the amount of mold release agent and/or emulsifier does not adequately address the molding problem.

The issues discussed above are particularly problematic in the formation of edible products, such as pet treats, and they occur both with formulations for pellet production and direct product production (i.e., without an intermediate step of forming pellets). For safety reasons, edible products should be easily digestable to prevent intestinal blockage if a large piece of the product is swallowed. A high level of hydrolyzed protein in a formulation aides digestibility, but also decreases structural integrity and complicates molding as discussed above. Further, it is known that digestibility of protein formulations can be improved by reducing protein curing time, but prior art formulations are unable to produce products with good texture and structural integrity using short molding cycle times.

### SUMMARY

The disclosed formulations and methods overcome the problems discussed above by incorporating one or more compounds such as calcium salts, magnesium salts, Na₂CO₃, NaOH, KOH, food grade phosphates and mixtures thereof into grain protein formulations.

In one aspect, a resin formulation useful for forming shaped articles and/or molded snacks includes a shelf-stabilizing agent present in an amount ranging from 0.5% to 25% by weight, grain protein ranging from 20% to 80% by weight and a compound selected from the group consisting of calcium salts, magnesium salts, Na₂CO₃, NaOH, KOH, Ba(OH)₂, BaO, phosphates and mixtures thereof. The shelf-stabilizing agent is selected from the group consisting of hydrolyzed protein, hydrolyzed protein derivatives, and hydrolyzed protein/hydrolyzed protein derivative-emulsifier complexes.

In one aspect, a chew treat product includes a shelf-stabilizing agent present in an amount ranging from 0.5% to 25% by weight, grain protein ranging from 20% to 80% by weight and a compound selected from the group consisting of calcium salts, magnesium salts, Na₂CO₃, NaOH, KOH, Ba(OH)₂, BaO, phosphates and mixtures thereof. The shelf-stabilizing agent is selected from the group consisting of hydrolyzed protein, hydrolyzed protein derivatives, and hydrolyzed protein/hydrolyzed protein derivative-emulsifier complexes. The shelf-stabilizing agent, the grain protein and the compound form a mixture that is shaped as a pet chew treat.

In one aspect, a method of forming grain protein pellets, which can be used in injection molding equipment for the production of articles, includes: providing a formulation comprising from 20% to 80% by weight grain protein; from 0.5% to 25% of a shelf-stabilizing agent selected from the group consisting of hydrolyzed proteins, hydrolyzed protein derivatives, hydrolyzed protein/hydrolyzed protein derivative-emulsifier complexes and mixtures thereof; and a compound selected from the group consisting of calcium salts, magnesium salts, Na₂CO₃, NaOH, KOH, Ba(OH)₂, BaO, phosphates and mixtures thereof; heating the formulation; and forming pellets by extrusion. The heating step is carried out so that the formulation is heated to a sufficient temperature in the extruder to render the formulation substantially homogeneous and flowable with the avoidance of any substantial heat denaturation of the grain protein formulation.

In one aspect, a method of forming a grain protein formulation, which can be used in injection molding equipment for the production of articles, includes: providing the grain protein formulation comprising from 20% to 80% by weight grain protein; from 0.5% to 25% of a shelf-stabilizing agent selected from the group consisting of hydrolyzed proteins, hydrolyzed protein derivatives, hydrolyzed protein/hydrolyzed protein derivative-emulsifier complexes and mixtures thereof; and a compound selected from the group consisting of calcium salts, magnesium salts, Na₂CO₃, NaOH, KOH, Ba(OH)₂, BaO, phosphates and mixtures thereof; heating and mixing the grain protein formulation to form a homogeneous and flowable melt, the melt having a temperature less than or equal to 95° C. to avoid substantial heat denaturation of the grain protein; and molding the melt into a shaped article using a mold that is maintained at a temperature from about 120-180° C. to substantially denature the grain protein.

### DETAILED DESCRIPTION

The term “percent (%)” as employed throughout the specification and claims refers to weight percent unless specifically noted in the text.

Pet treats with desirable texture and chew time, clean release from molding surfaces, shortened molding cycle times and improved digestibility are described herein. Ease of digestion is an important safety consideration for animals that are aggressive chewers. For example, an aggressive chewer might consume a large piece of a pet treat that could create an intestinal blockage if not quickly digested. Digestion of the grain protein product may be increased by (1) incorporating an amount of hydrolyzed protein into the formulation, (2) having a thin-wall design and/or (3) reducing grain protein curing time.

Broadly speaking, one method of producing an article of manufacture comprises a step of providing a formulation especially designed to have melt flow and theological properties that allow the formulation to be processed using conventional plastics-forming equipment. This formulation is heated under moderate temperature conditions, usually with shear, to create a substantially homogeneous and flowable mixture. In an optional step, the mixture is then extrusion processed to create resin pellets, which can later be melted and formed into desired articles using injection molding, extrusion or other forming equipment. Importantly, either the resin formulation or the original substantially homogeneous and flowable mixture is prepared with the avoidance of any substantial heat denaturation of the grain protein. During the formation of the final desired articles, the substantially undenatured protein is denatured. Thus, in the context of injection molding, the preferred temperature conditions of molding are selected to assure enough protein denaturation to set and form the product with good appearance, texture and integrity. It is also the case that certain water soluble denatured proteins, such as soy proteins, may be used in the mixtures, in which case the mixture may be further denatured or cured by the injection molding, extrusion or other forming equipment.

The resin aging problem discussed above is associated with chemical and/or conformational changes within the resin pellets. It has been discovered that shelf life of the resin formulations may be significantly extended by formulating an undenatured grain protein with a certain amount of shelf stabilizing agent, such as hydrolyzed proteins, hydrolyzed protein derivatives, hydrolyzed protein/hydrolyzed protein derivative-emulsifier complexes and mixtures thereof.

Heat denaturation of protein means the protein in its hydrated and plasticized state undergoes heat treatment that results in the protein losing some or most of its visco-elasticity or viscous flow (melt flow) property. The melt flow viscosity increases as the degree of heat denaturation increases. There is little or no melt flow property if the protein is completely heat denatured. For example, corn gluten meal coming out of the dryer of a wet milling process is severely heat denatured and, therefore, is not useful for providing the desired rheological properties of the resin formulations described herein. On the other hand, commercially available vital wheat gluten is processed to provide minimum heat denaturation and, in combination with the shelf-stabilizing agent(s), is a suitable grain protein source for the present formulations. Commercially available soy protein products may possess varying degrees of heat denaturation resulting from their preparation; however, most possess good melt flow properties with adequate plasticization due to the water solubility of soy protein. If the grain protein in a formulation is substantially denatured, it is not possible to obtain a satisfactory molded product with a smooth appearance and texture as well as good structural integrity.

In more detail, the preferred grain protein formulation includes one or more compounds selected from calcium salts, magnesium salts, Ba(OH)₂, BaO, Na₂CO₃, NaOH, KOH, food grade phosphates, such as Na₃PO₄, Na₂HPO₄, and calcium phosphates, and mixtures thereof. In particular, calcium salts may be selected from the group consisting of CaCO₃, Ca(OH)₂, CaO, CaCl₂, CaSO₄, calcium acetate, calcium lactate, calcium malate, calcium citrate, calcium phosphate, calcium butyrate, calcium propionate, calcium succinate, and mixtures thereof, and magnesium salts may be selected from the group consisting of MgCO₃, Mg(OH)₂, MgO,MgCl₂, MgSO₄, magnesium acetate, magnesium lactate, magnesium malate, magnesium citrate, magnesium phosphate, magnesium butyrate, magnesium propionate, magnesium succinate, and mixtures thereof. Pet treats with desirable texture and chew time, clean release from molding surfaces, shortened production cycle times and improved digestibility are made possible by the inclusion of such compounds. The amount of compound ranges from about 0.05% to about 10% by weight, preferably from about 0.075% to about 8% by weight, and more preferably from about 0.1-6% by weight. The amount of compound is such that the product pH is less than about 9.0, or between about 5.5-9.0, preferably between about 6.0-8.0, most preferably between about 6.5-7.5. Products with pH above 9.0 tend to have a very dark, undesirable color.

In more detail, the preferred grain protein formulation includes from about 20% to about 80% by weight grain protein, and preferably from 30% to 75%. Although a variety of grain proteins can be employed, most preferably the protein is selected from the group consisting of soy protein, wheat gluten, corn gluten and mixtures thereof. In preferred forms, the grain protein has substantially no heat denaturation and as used is naturally occurring. Normally, for reasons of economy and ease of formulation, the grain protein is provided as a part of a mixture which would typically include other optional ingredients such as starch, lipids, bran and combinations thereof. For example, soy meals, concentrates and isolates could be used, as well as various commercial grades of wheat and corn gluten. When such mixtures are used, typically they would provide at least about 50% by weight of the desired grain protein, and more preferably at least about 75% by weight thereof.

A hydrolyzed protein, a hydrolyzed protein derivative, and/or a hydrolyzed protein/hydrolyzed protein derivative-emulsifier complex may be incorporated into the grain protein formulation. Hydrolyzed proteins to be employed in the formulation may, for example, include hydrolyzed yeast protein, hydrolyzed wheat gluten, hydrolyzed soy protein, hydrolyzed corn gluten, hydrolyzed potato protein, hydrolyzed rice protein, hydrolyzed gelatin protein, hydrolyzed collagen, hydrolyzed casein, hydrolyzed whey protein, hydrolyzed milk protein, hydrolyzed egg white, hydrolyzed egg yoke, hydrolyzed whole egg, hydrolyzed chicken liver, hydrolyzed pork liver, hydrolyzed beef liver, hydrolyzed fish liver, hydrolyzed meat protein of any source, hydrolyzed fish, hydrolyzed blood plasma, hydrolyzed yeast protein and mixtures thereof. Preferred protein hydrolyzates are hydrolyzed wheat gluten, hydrolyzed soy protein, and hydrolyzed liver proteins. The hydrolyzed protein is generally present in a range of from about 0.5% to about 25% by weight of the formulation. Preferred is a hydrolyzed protein amount of from about 1.5% to about 20% by weight. Particularly preferred is a hydrolyzed protein amount of from about 2% to about 15% by weight.

One hydrolyzed protein that has proven to be particularly useful as a shelf-stabilizing agent is autolyzed yeast protein. Resins comprising this agent, when formed into pellets by injection molding, exhibit a shelf life in excess of six months. The exact composition of useful autolyzed yeast proteins is not critical. Generic versions have worked well.

The hydrolyzed proteins that best address the aging problem of resin pellets have a number average molecular weight and weight average molecular weight less than 20,000 and 40,000 Daltons, respectively.

Hydrolyzed proteins may be prepared by any means known in the art. Typically, enzymatic hydrolysis or acid hydrolysis is employed. The protein hydrolyzate is typically adjusted to a pH of 4-7.5 using NaOH, KOH, Ca(OH)₂ or the like before spray or flash drying the product.

Examples of hydrolyzed protein derivatives include reaction products of protein hydrolyzates with other chemicals or low molecular weight polymer or oligomer ingredients. The reaction products contain a hydrolyzed protein moiety and a derivative portion. The amount of hydrolyzed protein in the derivative reaction products may range from about 0.5% to about 50% depending on the reaction chemicals used. Examples are reaction products of hydrolyzed protein with anhydride, ethylene oxide, propylene oxide, fatty acid derivatives, reducing sugars, maltodextrin, oligosaccharides, dextrin and the like.

The amount of hydrolyzed protein derivatives to be employed in the formulation may be from about 0.5% to about 25%. Preferred is a hydrolyzed protein derivative amount of from about 1.5% to about 20%. Particularly preferred is a hydrolyzed protein derivative amount of from about 2% to about 15%.

The hydrolyzed protein/hydrolyzed protein derivative-emulsifier complex may be prepared from hydrolyzed protein moieties and hydrolyzed protein derivative moieties bonded physically with emulsifiers. Suitable emulsifiers include hydrolyzed vegetable oil, hydrolyzed animal fat, hydrolyzed lecithin and their salt forms, hydrolyzed lecithin modified further by ethylene oxide and propylene oxide, ethoxylated mono- and diglycerides, diacetyl tartaric acid ester of mono- and diglycerides, sugar esters of mono- and diglycerides, propylene glycol mono- and diesters of fatty acids, calcium stearoyl-2-lactylate, lactylic stearate, sodium stearoyl fumarate, succinylated monoglyceride, sodium stearoyl-2-lactylate, polysorbate 60, or any other emulsifier that contains both hydrophobic and hydrophilic portions in the structure, and mixtures thereof. The amount of emulsifier in the complex is from about 10-30% by weight of the complex.

The amount of hydrolyzed protein/hydrolyzed protein derivative-emulsifier complex to be employed in the formulation for resin production may be from about 0.5% to about 25%. Preferred is a hydrolyzed protein/hydrolyzed protein derivative-emulsifier complex amount of from about 1.5% to about 20%. Particularly preferred is a hydrolyzed protein/hydrolyzed protein derivative-emulsifier complex amount of from about 2% to about 15%.

The formulation of resin pellets may also contain from about 10-40% plasticizers in the starting formulations, and more preferably from about 10-35% by weight. The preferred class of plasticizers includes those selected from the group consisting of glycerol, diglycerol, propylene glycol, triethylene glycol, urea, sorbitol, mannitol, maltitol, hydrogenated corn syrup, polyvinyl alcohol, polyethylene glycol and mixtures thereof. The most preferred plasticizer is glycerol.

The grain protein formulations may also include a minor amount of water, up to 14% by weight, more preferably up to about 13% by weight, and most preferably up to about 12% by weight. The moisture content in the resin pellets is preferably controlled from about 5-13%.

The formulation of resin pellets may also contain from about 0.5% to 5% lubricants. The presence of lubricants helps the extrusion process and molding operation by facilitating ease of melt flow and melt temperature control. The lubricants may include glycerol mono/di-stearate, hydrolyzed lecithin and derivatives, fatty acid and derivatives. The preferred lubricant is glycerol monostearate.

The formulation of resin pellets may also contain from about 0.5% to 3% mold release agents. The presence of such mold release agents prevents the parts or articles from sticking to the molding surfaces or processing surfaces in general. The mold release agents may be magnesium stearate, calcium stearate, barium stearate or other alkaline earth metal fatty acid agents. A particularly preferred mold release agent is magnesium stearate.

The formulation of resin pellets may also contain from about 0.01% to 5% reducing agent. The reducing agent cleaves the disulfide bonds in the grain protein. This drastically improves the flow and mixing of the grain protein in the processing equipment, rendering the overall formulation more suitable for use therein. The reducing agent is present in a minor amount of at least about 0.01% by weight, preferably from about 0.05-5% by weight, and more preferably from about 0.05-3% by weight, where these weights are based upon the total amount of grain protein being taken as 100% by weight. The reducing agents are advantageously selected from the group consisting of alkali metal and ammonium sulfites, bisulfites, metabisulfites and nitrites, and mercaptoethanol, cysteine, cysteamine, sulfur dioxide, ascorbic acid and mixtures thereof. A particularly preferred reducing agent is sodium metabisulfite.

Normally, the reducing agent is simply added to the other components of the formulation prior to or as a part of the extrusion process. Alternatively, the reducing agent can be used to preliminarily treat the selected grain protein(s) prior to preparation of the starting formulation. Thus, in the case of gluten products (wheat and corn gluten), the reducing agent may be initially added to obtain a modified gluten product which then is employed as a part of the extrusion formulation. In any case, the reducing agent is preferably used in an effective amount to cleave from about 5-100% of the disulfide bonds in the grain protein.

Dairy proteins and/or animal proteins up to about 30% can also be incorporated into the grain protein formulations to enhance the nutritional profile of the products without necessarily affecting the product appearance, texture or digestibility.

A number of other ingredients can also be used in the grain protein formulations. These optional ingredients may include: (1) starches, such as native, gelatinized and/or chemically modified starches (e.g., wheat starch, corn starch, potato starch, rice starch, tapioca starch and mixtures thereof, with chemical modifications being hydrolysis, oxidation, acetylation, carboxymethylation, hydroxyethylation, hydroxypropylation and alkylation); (2) fillers, such as heat denatured animal or vegetable protein granules or powder; vegetable powder; granules or special shape-cuts; rice flour; wheat flour; corn gluten meal; and fibers (e.g., cellulose fiber, micro-crystalline fiber, soluble fibers, wheat bran, soy bean fiber and corn grit fiber); (3) cooked flours from wheat, corn, potato, rice, etc.; (4) pigments (e.g., titanium dioxide, carbon black and talc); (5) coloring agents (e.g., azo dyes, chlorophyll, xanthophyll, carotene, indigo, all the synthetic colors, and natural coloring agents); (6) foaming agents (e.g., sodium bicarbonate, N₂ and CO₂); and (7) other special effect ingredients such as breathe and dental cleaning ingredients. These optional ingredients may, for example, provide from about 0.001% to 75% by weight of the resin pellets.

The present formulations can be formed into pellets which are generally maintained in closed containers and have a moisture content ranging from about 5% to about 13%. The pellets can later be used in molding equipment or shaped by various methods, as illustrated in U.S. Pat. No. 5,665,152. For example, such pellets may be formed by extrusion, using either single or twin screw extruders. However, it is important to maintain the temperature of the material within the extruder barrel below about 95° C. to avoid heat denaturation of the matrix grain protein content of the formulation. The formulations may be shaped or molded into any desired object, for example using injection molding. The melt temperature inside the barrel of the injection molder should be maintained at a level of up to about 95° C., and more preferably up to about 80° C. However, the mold itself is normally heated to a temperature of from about 120 to about 180° C., in order to denature the grain protein fraction of the formulation that is introduced into the injection mold. Cycle time of the molding process is reduced substantially from about 35-50 seconds for formulations that do not contain compounds such as calcium salts, magnesium salts, Ba(OH)₂, BaO, Na₂CO₃, NaOH, KOH, food grade phosphates and mixtures thereof to about 10-20 seconds for the present formulations.

The grain protein formulation can also be used without forming resin pellets during an intermediate step. Using this method, the homogeneous and flowable melt created by mixing at temperatures up to about 95° C. is injected directly into the mold kept at a temperature ranging from about 120-180° C. An injection molding compounder (IMC) may be used for such processing, as shown in the following examples, which illustrate specific formulations and methods of preparing the resin pellets and molded articles.

### EXAMPLES

### Sources and Identity of Materials

Vital Wheat Gluten is a commercially available wheat gluten made by a flash drying process (MGP Ingredients, Inc., Atchison, Kans.). Wheat gluten can also be made by spray drying so long as the proteins are not denatured, such that they lose visco-elasticity or other viscous properties after hydration.

HWG 2009 PC is a commercially available lightly hydrolyzed wheat gluten (MGP Ingredients, Inc.).

SC 90 is a commercially available cellulose powder (Creafill Fibers Corp.).

Naturex plus natural tocopherols are commercially available from Kemin Industries, Inc.

Optimizor™ is a trademark of Applied Food Biotechnology, Inc., and contains hydrolyzed liver protein derivatives. Specifically, maltodextrin is complexed with hydrolyzed animal fat/vegetable oil.

Supro 670 is a commercially available soy protein isolate (The Solae Company).

Ameripro milk protein concentrate is available from JLS Foods International.

VITACAL H is a commercially available calcium hydroxide (Mississippi Lime Company).

Vitality Extra Light Calcium Carbonate is available from Specialty Minerals.

CHX H-base is a commercially available palatability enhancer (Applied Food Biotechnology, Inc.).

### Example 1

### Base Protein Molding Formulation

| Ingredient Name | Powder Formula | Total Formula |
|---|---|---|
| Wheat Gluten | 76.69% | 58.09% |
| Lightly Hydrolyzed Wheat Gluten | 13.20% | 10.00% |
| Palatability Enhancer | 4.40% | 3.33% |
| Cellulose Powder | 2.50% | 1.89% |
| Glycerol Monostearate | 1.50% | 1.14% |
| Magnesium Stearate | 1.00% | 0.76% |
| Calcium Hydroxide | 0.66% | 0.50% |
| Tocopherols | 0.05% | 0.04% |
| Glycerin | 24.40% | 18.48% |
| Water | 4.80% | 3.64% |
| Vegetable Oil | 2.70% | 2.04% |
| Sodium Metabisulfite | 0.13% | 0.10% |
| TOTAL | 132.03% | 100.00% |

Example 1 shows a general resin formulation containing 10% hydrolyzed wheat gluten protein and 0.5% calcium hydroxide. The presence of 10% hydrolyzed wheat gluten increases digestibility and the presence of 0.5% calcium hydroxide provides clean release of the molded article from the molding surfaces, improved texture and appearance, and reduced molding cycle time.

### Example 2

### Formulation One

| | Formulation |
|---|---|
| Ingredient Name | parts by weight |
| Vital Wheat Gluten | 70 |
| HWG 2009 (lightly hydrolyzed wheat gluten) | 18 |
| Optimizer H-base (palatability enhancer) | 4.5 |
| SC 90 (cellulose powder) | 2.5 |
| Glycerol monostearate | 1.5 |
| Magnesium stearate | 1.0 |
| VITACAL H (calcium hydroxide) | 0.66 |
| Naturex plus (natural tocopherols) | 0.05 |
| Glycerin | 24.0 |
| Water | 6.5 |
| Soybean oil | 2.5 |
| Sodium metabisulfite | 0.13 |

The formulation of Example 2 provides specific ingredients corresponding to those generally disclosed in Example 1. This formulation contains about 13.7% hydrolyzed wheat gluten and about 0.5% calcium hydroxide.

### Example 3

### Formulation Two

| | Formulation |
|---|---|
| Ingredient Name | parts by weight |
| Vital Wheat Gluten | 53.0 |
| HWG 2009 PC (lightly hydrolyzed wheat gluten) | 20.5 |
| Supro 670 (soy protein isolate) | 13 |
| CHX H-base (palatability enhancer) | 4.8 |
| SC 90 (cellulose powder) | 4.0 |
| Glycerol monostearate | 2.0 |
| Magnesium stearate | 1.0 |
| Vitality Extra Light Calcium Carbonate | 0.5 |
| VITACAL H (Calcium hydroxide) | 0.5 |
| Naturex plus dry-K (natural tocopherols) | 0.05 |
| Glycerin | 24.0 |
| Water | 8.5 |
| Soybean oil | 2.0 |
| Sodium metabisulfite | 0.13 |

The formulation of Example 3 provides specific ingredients corresponding to those generally disclosed in Example 1. This formulation contains about 15.3% hydrolyzed wheat gluten, about 9.7% soy protein isolate and about 0.37% calcium hydroxide.

### Example 4

### Formulation Three

| | Formulation |
|---|---|
| Ingredient Name | parts by weight |
| Vital Wheat Gluten | 53.0 |
| HWG 2009 PC (lightly hydrolyzed wheat gluten) | 20.5 |
| Ameripro Milk protein concentrate | 13.0 |
| CHX H-base (palatability enhancer) | 4.8 |
| SC 90 (cellulose powder) | 4.0 |
| Glycerol monostearate | 2.0 |
| Magnesium stearate | 1.0 |
| Vitality Extra Light Calcium Carbonate | 0.5 |
| VITACAL H (Calcium hydroxide) | 0.5 |
| Naturex plus dry-K (natural tocopherols) | 0.05 |
| Glycerin | 24.0 |
| Water | 8.5 |
| Soybean oil | 2.0 |
| Sodium metabisulfite | 0.13 |

The formulation of Example 4 provides specific ingredients corresponding to those generally disclosed in Example 1. This formulation contains about 15.3% hydrolyzed wheat gluten, about 9.7% milk protein concentrate and about 0.37% calcium hydroxide.

### Example 5

### Injection Molding of Pet Treats

The formulations of Examples 2-4 were molded on a production scale KM-650 Injection Molding Compounder (IMC). Powder ingredients were mixed together in a batch mixer and transferred to a hopper of the IMC machine. Water miscible liquid ingredients were mixed together, as were oil miscible liquid ingredients. Both the aqueous solution and the oil solution were pumped directly into the extruder barrel. Powder and liquids were mixed to form a homogeneous and flowable melt under conditions of heat and twin screw mixing action. Barrel temperatures were maintained at 70° C. The melt was extruded into an injection chamber timed with the piston retrieve action of the injection chamber. The injection chamber temperature was set at 70-80° C. (80° C. towards the nozzle end). The mold temperature was set at 140° C. Molding with good part release was achieved with a short cycle time of 15-20 seconds, instead of more than 35 seconds typically required without calcium hydroxide. After part release, products were cooled naturally to room temperature for packaging. Depending upon market needs, a coating can be applied using a drum coater before final packaging.

### Example 6

### Digestion Study

Dog treats formed as disclosed in Example 5 by an injection molding compounder were tested for digestibility. Treats having a cross-sectional thickness of 5 mm were used for an enzyme digestion study. A 5 gram sample of each treat (corresponding to the formulations disclosed in Examples 2-4) was immersed in a 100 ml pepsin enzyme solution of 0.1 M HCl containing 0.25% pepsin. Erlenmeyer flasks containing enzyme solution and samples were shaken in a water bath controlled at 39° C. All samples were completely digested within 20 hours.

The detailed description set forth above and the various compositions and methods described in that detailed description do not, cannot, and are not intended to limit the scope of this application or any patent that issues from this application. The sole measure of the scope of this application is the claims that follow, expanded under the Doctrine of Equivalents where authorized by law.

We claim:

1. A resin formulation useful for forming shaped articles and/or molded snacks, comprising:
a shelf-stabilizing agent selected from the group consisting of hydrolyzed protein, hydrolyzed protein derivatives, and hydrolyzed protein/hydrolyzed protein derivative-emulsifier complexes,
the shelf stabilizing agent being present in an amount ranging from 0.5% to 25% by weight of the resin formulation;
grain protein ranging from 20% to 80% by weight of the resin formulation; and
a compound selected from the group consisting of calcium salts, magnesium salts, Na₂CO₃, NaOH, KOH, Ba(OH)₂, BaO, phosphates and mixtures thereof.

2. The resin formulation of claim 1, wherein the amount of the compound ranges from 0.05% to 10% by weight.

3. The resin formulation of claim 1, wherein the calcium salt is selected from the group consisting of CaCO₃, Ca(OH)₂, CaO, CaCl₂, CaSO₄, calcium acetate, calcium lactate, calcium malate, calcium citrate, calcium phosphate, calcium butyrate, calcium propionate, calcium succinate, and mixtures thereof.

4. The resin formulation of claim 1, wherein the magnesium salt is selected from the group consisting of MgCO₃, Mg(OH)₂, MgO, MgCl₂, MgSO₄, magnesium acetate, magnesium lactate, magnesium malate, magnesium citrate, magnesium phosphate, magnesium butyrate, magnesium propionate, magnesium succinate, and mixtures thereof.

5. The resin formulation of claim 1 shaped into one of an edible product and a biodegradable product according to a process that includes at least one step of injection molding the resin formulation or extruding the resin formulation.

6. The resin formulation of claim 1 shaped to form a pet chew treat.

7. The resin formulation of claim 1, wherein the shelf-stabilizing agent is selected from the group consisting of:
(a) the hydrolyzed protein selected from the group consisting of hydrolyzed wheat gluten, hydrolyzed soy protein, hydrolyzed corn gluten, hydrolyzed potato protein, hydrolyzed rice protein, hydrolyzed gelatin protein, hydrolyzed collagen, hydrolyzed casein, hydrolyzed whey protein, hydrolyzed milk protein, hydrolyzed egg white, hydrolyzed egg yoke, hydrolyzed whole egg, hydrolyzed chicken liver, hydrolyzed pork liver, hydrolyzed beef liver, hydrolyzed fish liver, hydrolyzed meat protein of any source, hydrolyzed fish, hydrolyzed blood plasma, hydrolyzed yeast protein and mixtures thereof,
(b) the hydrolyzed protein derivative comprising a reaction product of a protein hydrolyzate with at least one reagent selected from the group consisting of an anhydride, ethylene oxide, propylene oxide, fatty acid, reducing sugars, maltodextrin, oligosaccharide and dextrin; and
(c) the hydrolyzed protein/hydrolyzed protein derivative contacting an emulsifier selected from the group consisting of hydrolyzed vegetable oil, hydrolyzed animal fat, hydrolyzed lecithin and their salt forms, hydrolyzed lecithin modified further by ethylene oxide and propylene oxide, ethoxylated mono- and diglycerides, diacetyl tartaric acid ester of mono- and diglycerides, sugar esters of mono- and diglycerides, propylene glycol mono- and diesters of fatty acids, calcium stearoyl-2-lactylate, lactylic stearate, sodium stearoyl fumarate, succinylated monoglyceride, sodium stearoyl-2-lactylate, polysorbate 60, or any other emulsifier that contains both hydrophobic and hydrophilic portions in the structure and mixtures thereof.

8. The resin formulation of claim 1, wherein the grain protein is selected from the group consisting of wheat gluten, corn gluten, soy protein, and mixtures thereof.

9. The resin formulation of claim 1, further comprising a plasticizer ranging from 10% to 40% by weight of the resin formulation, the plasticizer selected from the group consisting of glycerol, diglycerol, propylene glycol, triethylene glycol, urea, sorbitol, mannitol, maltitol, hydrogenated corn syrup, polyvinyl alcohol, polyethylene glycol and mixtures thereof.

10. The resin formulation of claim 1, further comprising water ranging from 5% to 13% by weight of the resin formulation.

11. The resin formulation of claim 1, further comprising a lubricant ranging from 0.5% to 5% by weight of the resin formulation, the lubricant selected from the group consisting of glycerol mono/di-stearate, hydrolyzed lecithin, hydrolyzed lecithin derivatives, fatty acid, fatty acid derivatives and mixtures thereof.

12. The resin formulation of claim 1, further comprising a mold release agent ranging from 0.5% to 3% by weight of the resin composition, the mold release agent selected from the group consisting of magnesium stearate, calcium stearate, barium stearate, alkaline earth metal fatty acids and mixtures thereof.

13. The resin formulation of claim 1, further comprising a reducing agent ranging from 0.01% to 5% by weight of the grain protein, the reducing agent selected from the group consisting of alkali metal sulfites, ammonium sulfites, bisulfites, metabisulfites, nitrites, mercaptoethanol, cysteine, cysteamine, sulfur dioxide, ascorbic acid and mixtures thereof.

14. The resin formulation of claim 1, further comprising native, gelatinized or chemically modified starch and selected from the group consisting of wheat starch, corn starch, potato starch, rice starch, tapioca starch and mixtures thereof.

15. The resin formulation of claim 14, wherein the chemically modified starch is a reaction product of native starch subjected to hydrolysis, oxidation, acetylation, carboxymethylation, hydroxyethylation, hydroxypropylation, alkylation and mixtures thereof.

16. The resin formulation of claim 14, wherein the starch ranges from 0.001% to 70% by weight of the resin formulation.

17. The resin formulation of claim 1, further comprising cooked flour selected from the group consisting of wheat flour, corn flour, rice flour, potato flour and combinations thereof.

18. The resin formulation of claim 1, further comprising an additional ingredient ranging up to 75% by weight of the resin formulation, the additional ingredient selected from the group consisting of:
(a) a filler including heat denatured protein, vegetable powder, rice flour, wheat flour, corn gluten meal, and fibers;
(b) cooked flour;
(c) pigments;
(d) coloring agents;
(e) foaming agents;
(f) other special effect ingredients of predetermined functionality; and
(g) mixtures thereof.

19. A chew treat product comprising:
a shelf-stabilizing agent selected from the group consisting of hydrolyzed protein, hydrolyzed protein derivatives, and hydrolyzed protein/hydrolyzed protein derivative-emulsifier complexes,
the shelf-stabilizing agent being present in an amount ranging from 0.5% to 25% by weight of the resin formulation;
grain protein ranging from 20% to 80% by weight of the resin formulation; and
a compound selected from the group consisting of calcium salts, magnesium salts, Na₂CO₃, NaOH, KOH, Ba(OH)₂, BaO, phosphates and mixtures thereof,
the shelf-stabilizing agent, the grain protein and the compound forming a mixture that is shaped as a pet chew treat.

20. The resin formulation of claim 19, wherein the calcium salt is selected from the group consisting of CaCO₃, Ca(OH)₂, CaO, CaCl₂, CaSO₄, calcium acetate, calcium lactate, calcium malate, calcium citrate, calcium phosphate, calcium butyrate, calcium propionate, calcium succinate, and mixtures thereof.

21. The resin formulation of claim 19, wherein the magnesium salt is selected from the group consisting of MgCO₃, Mg(OH)₂, MgO, MgCl₂, MgSO₄, magnesium acetate, magnesium lactate, magnesium malate, magnesium citrate, magnesium phosphate, magnesium butyrate, magnesium propionate, magnesium succinate, and mixtures thereof

22. A method of forming grain protein pellets, which can be used in injection molding equipment for the production of articles, the method comprising the steps of:
(a) providing a formulation comprising from 20% to 80% by weight grain protein; from 0.5% to 25% of a shelf-stabilizing agent selected from the group consisting of hydrolyzed proteins, hydrolyzed protein derivatives, hydrolyzed protein/hydrolyzed protein derivative-emulsifier complexes and mixtures thereof; and a compound selected from the group consisting of calcium salts, magnesium salts, Na₂CO₃, NaOH, KOH, Ba(OH)₂, BaO, phosphates and mixtures thereof;
(b) heating the formulation; and
(c) forming pellets by extrusion, the heating step being carried out so that the formulation is heated to a sufficient temperature in the extruder to render the formulation substantially homogeneous and flowable with the avoidance of any substantial heat denaturation of the grain protein formulation.

23. The resin formulation of claim 22, wherein the calcium salt is selected from the group consisting of CaCO₃, Ca(OH)₂, CaO, CaCl₂, CaSO₄, calcium acetate, calcium lactate, calcium malate, calcium citrate, calcium phosphate, calcium butyrate, calcium propionate, calcium succinate, and mixtures thereof.

24. The resin formulation of claim 22, wherein the magnesium salt is selected from the group consisting of MgCO₃, Mg(OH)₂, MgO, MgCl₂, MgSO₄, magnesium acetate, magnesium lactate, magnesium malate, magnesium citrate, magnesium phosphate, magnesium butyrate, magnesium propionate, magnesium succinate, and mixtures thereof.

25. The method of claim 22, wherein heating step is performed at a maximum temperature less than or equal to 95° C.

26. The method of claim 22, wherein the formulation contains from 0.001% to 75% by weight of granular starch.

27. The method of claim 26, the starch being selected from the group consisting of corn starch, wheat starch, potato starch, tapioca starch and mixtures thereof.

28. The method of claim 22, wherein the formulation contains from 0.01% to 5% of a reducing agent by weight of the grain protein, the reducing agent selected from the group consisting of the alkali metal and ammonium sulfites, bisulfites, metabisulfites and nitrites, and mercaptoethanol, cysteine, cysteamine, sulfur dioxide, ascorbic acid and mixtures thereof.

29. The method of claim 22, wherein the grain protein is selected from the group consisting of soy protein, wheat gluten, corn gluten, and mixtures thereof.

30. The method of claim 22, further comprising a plasticizer in an amount from 10 to 40%, the plasticizer selected from the group consisting of glycerol, diglycerol, propylene glycol, triethylene glycol, urea, sorbitol, mannitol, maltitol, hydrogenated corn syrup, polyvinyl alcohol, polyethylene glycol, C₁₂-C₂₂ fatty acids and metal salts of such fatty acids and mixtures thereof.

31. The method of claim 22, wherein the formulation contains a lubricant/mold release agent present at a level ranging from 0.5% to 3.0% by weight of the formulation, the lubricant/mold release agent selected from the group consisting of vegetable and animal oils and fats, the alkali metal and alkaline earth stearates and mixtures thereof.

32. The method of claim 22, further comprising the steps of:
passing the pellets through injection molding equipment having a barrel and a mold capable of forming an article,
the passing step comprising the steps of rendering the pellets flowable in the barrel while maintaining the temperature of the flowable pellet material up to a maximum temperature less than 95° C., and
heating the mold to a temperature of from 120° C. to 180° C.

33. The method of claim 32, further comprising a step of transferring the flowable pellet material into the mold to form the article.

34. The method of claim 33, wherein the article produced in the transferring step is a pet chew treat.

35. A method of forming a grain protein formulation, which can be used in injection molding equipment for the production of articles, the method comprising the steps of:
(a) providing the grain protein formulation comprising from 20% to 80% by weight grain protein; from 0.5% to 25% of a shelf-stabilizing agent selected from the group consisting of hydrolyzed proteins, hydrolyzed protein derivatives, hydrolyzed protein/hydrolyzed protein derivative-emulsifier complexes and mixtures thereof; and a compound selected from the group consisting of calcium salts, magnesium salts, Na₂CO₃, NaOH, KOH, Ba(OH)₂, BaO, phosphates and mixtures thereof;
(b) heating and mixing the grain protein formulation to form a homogeneous and flowable melt, the melt having a temperature less than or equal to 95° C. to avoid substantial heat denaturation of the grain protein; and
(c) molding the melt into a shaped article using a mold that is maintained at a temperature from about 120-180° C. to substantially denature the grain protein.

36. The resin formulation of claim 35, wherein the calcium salt is selected from the group consisting of CaCO₃, Ca(OH)₂, CaO, CaCl₂, CaSO₄, calcium acetate, calcium lactate, calcium malate, calcium citrate, calcium phosphate, calcium butyrate, calcium propionate, calcium succinate, and mixtures thereof.

37. The resin formulation of claim 35, wherein the magnesium salt is selected from the group consisting of MgCO₃, Mg(OH)₂, MgO, MgCl₂, MgSO₄, magnesium acetate, magnesium lactate, magnesium malate, magnesium citrate, magnesium phosphate, magnesium butyrate, magnesium propionate, magnesium succinate, and mixtures thereof.
